(19) United States
(12) Patent Application Publication
(10) Pub. No.: US 2016/0335096 A1
(43) Pub. Date: Nov. 17, 2016

(54) BOOTING CONTROL SYSTEM AND MOTHERBOARD HAVING THE SAME

(71) Applicants: HONG FU JIN PRECISION INDUSTRY (Shenzhen) CO., LTD., Shenzhen (CN); HON HAI PRECISION INDUSTRY CO., LTD., New Taipei (TW)

(72) Inventors: KANG WU, Shenzhen (CN); GUO-YI CHEN, Shenzhen (CN)

(21) Appl. No.: 14/755,413

(22) Filed: Jun. 30, 2015

(30) Foreign Application Priority Data
May 11, 2015 (CN) 201510235608.7

(51) Int. Cl. G06F 9/44; G06F 13/42; G06F 13/40

(52) U.S. Cl. CPC G06F 9/4405; G06F 13/4022; G06F 13/4282

(57) ABSTRACT

A booting control system includes a control module, a switch module, a sense module, a first basic input output system (BIOS) chip, and a second BIOS chip. The control module configured to receive a power on signal and a reset signal. The switch module is coupled to the control module. The sense module is configured to sense the reset signal and output a control signal to the switch module. When the switch module receives the control signal from the sense module, the control module can transmit data with the second BIOS chip through the switch module.

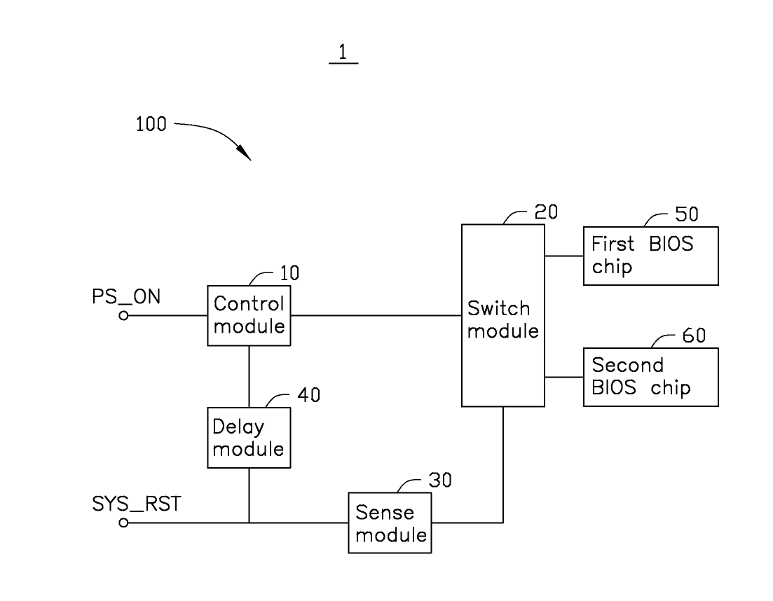

### FIELD

The subject matter herein generally relates to a booting control system and a motherboard having the same.

### BACKGROUND

A booting time of a motherboard of a server is shorter than an initialization time of a plurality of hard disks connected to the server. When the server boots, a booting delay program is needed to wait the initialization of the hard disks, which result in a long time is wasted when the server is reset.

### BRIEF DESCRIPTION OF THE DRAWINGS

Implementations of the present technology will now be described, by way of example only, with reference to the attached FIGURE.

The FIGURE is a block diagram of an example embodiment of a booting control system.

### DETAILED DESCRIPTION

It will be appreciated that for simplicity and clarity of illustration, where appropriate, reference numerals have been repeated among the different FIGURES to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The term “comprising,” when utilized, means “including, but not necessarily limited to”; it specifically indicates open-ended inclusion or membership in the so-described combination, group, series and the like.

The present disclosure is described in relation to a booting control system 100.

The FIGURE illustrates an embodiment of the booting control system 100 set on a motherboard 1 of a server. The booting control system 100 can be configured to boot the server and comprise a control module 10, a switch module 20, a sense module 30, a delay module 40, a first basic input output system (BIOS) chip 50, and a second BIOS chip 60.

A first BIOS is loaded in the first BIOS chip 50 and a second BIOS is loading in the second BIOS chip 60. The first BIOS and the second BIOS can comprise BIOS setup program, system setup, power on self test program, and system boot program. In at least one embodiment, the first BIOS comprises a booting delay program. When the motherboard 1 is activated by the first BIOS chip 50, a booting time of the server can be increased for waiting an initialization of the plurality of hard disks. When the motherboard 1 is activated by the second BIOS chip 60, the server boots normally.

The control module 10 is configured to receive a power on signal PS_ON. The first BIOS chip 50 and the second BIOS chip 60 are coupled to the control module 10 through the switch module 20. The sense module 30 is configured to sense a reset signal SYS_RST of the server. The switch module 20 is coupled to the sense module 30 for receiving a control signal from the sense module 30, when the reset signal SYS_RST is sensed by the sense module 30. The control module 10 can transmit data with the first BIOS chip 50 through the switch module 20, when the switch module 20 does not receive the control signal from the sense module 30. The control module 10 can transmit data with the second BIOS chip 60 through the switch module 20, when the switch module 20 receives the control signal from the sense module 30. The control module 10 is also configured to receive the reset signal SYS_RST through the delay module 40. The delay module 40 is configured to output the reset signal SYS_RST to the control module 10 after a preset time t. In the other embodiment, the delay module 40 can be omitted.

In at least one embodiment, the control module 10 is a platform controller hub (PCH). The sense module 30 is a baseboard management controller (BMC).

When the server is booting, the control module 10 receives the power on signal PS_ON, and the sense module 30 does not sense the reset signal SYS RST of the server. The control module 10 can communicate with the first BIOS chip 50 through the switch module 20. Therefore, the motherboard 1 of the server is activated by the first BIOS chip 50, which making the server booting.

When the server is needed to be reset, the reset signal SYS_RST is detected by the sense module 30. The switch module 20 receives the control signal from the sense module 30 , and controls the control module 10 to communicate with the second BIOS chip 60. At that time, the control module 10 receives the reset signal SYS_RST after the preset time t. The control module 10 starts to communicate with the second BIOS chip 60, and the server boots through the second BIOS chip 60. Therefore, the motherboard 1 of the server is activated by the second BIOS chip 60, which making the server booting rapidly.

The embodiments shown and described above are only examples. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. A booting control system comprising:
a control module configured to receive a power on signal and a reset signal;
a switch module coupled to the control module;
a sense module coupled to the switch module, the sense module configured to sense the reset signal and output a control signal to the switch module;
a first basic input output system (BIOS) chip coupled to the switch module; and
a second BIOS chip coupled to the switch module;
wherein when the switch module receives the control signal from the sense module, the control module can transmit data with the second BIOS chip through the switch module.

2. The booting control system of claim 1, wherein a booting delay program is loaded in the first BIOS chip.

3. The booting control system of claim 1, further comprising a delay module, wherein the control module receives the reset signal through the delay module.

4. The booting control system of claim 1, wherein the control module is a platform controller hub (PCH).

5. The booting control system of claim 1, wherein the sense module is a baseboard management controller (BMC).

6. A motherboard comprising:
a booting control system comprising:
a control module configured to receive a power on signal and a reset signal of the motherboard;
a switch module coupled to the control module;
a sense module coupled to the switch module, the sense module configured to sense the reset signal and output a control signal to the switch module;
a first basic input output system (BIOS) chip coupled to the switch module; and
a second BIOS chip coupled to the switch module;
wherein when the switch module receives the control signal from the sense module, the control module can transmit data with the second BIOS chip through the switch module.

7. The motherboard of claim 6, wherein a booting delay program is loaded in the first BIOS chip.

8. The motherboard of claim 6, wherein the booting control system further comprising a delay module, wherein the control module receives the reset signal through the delay module.

9. The motherboard of claim 6, wherein the control module is a platform controller hub (PCH).

10. The motherboard of claim 6, wherein the sense module is a baseboard management controller (BMC).
